(19) United States
(12) Patent Application Publication
(10) Pub. No.: US 2024/0009728 A1
(43) Pub. Date: Jan. 11, 2024

(54) DEVICE AND METHOD FOR WORKING A WEB OF MATERIAL WITH WORKPIECES SECURED THEREIN, MULTISTAGE PROGRESSION TOOL, SINGLE MODULE, ASSEMBLY OF MULTIPLE SINGLE MODULES OF SAID TYPE, INDIVIDUAL TOOL, AND FACILITY FOR WORKING A WEB OF MATERIAL

(71) Applicant: Clusteron Gesellschaft MBH, Clenze (DE)

(72) Inventor: Sabine Stamm, Clenze (DE)

(21) Appl. No.: 18/250,009

(22) PCT Filed: Oct. 21, 2021
(86) PCT No.: PCT/EP2021/079258

§ 371 Date: Apr. 21, 2023

(30) Foreign Application Priority Data
Oct. 22, 2020 (LU) LU102201

(51) Int. Cl. B21D 37/08; B21D 37/02; B30B 15/30; B30B 15/14

(52) U.S. Cl. CPC B21D 37/08; B21D 37/02; B30B 15/30; B30B 15/146

(57) ABSTRACT

The invention relates to an apparatus for working, in particular for working without machining, for example for separating and/or forming, a web of material, having a plurality of individual tools for different manners of working the web of material with designated workpieces temporarily held therein, and having a machine direction along which the web of material with the designated workpieces and the plurality of individual tools can be moved incrementally relative to one another in such a way that the web of material can be worked multiple times within one work cycle by means of the plurality of individual tools, wherein the individual tools are designed as individual modules which can be fixed to one another to form an individual module cluster, but can be detached as well.

The invention relates to an apparatus for working, in particular for working without machining, for example for separating and/or forming, a web of material, having a plurality of individual tools for different manners of working the web of material with designated workpieces temporarily held therein, and having a machine direction along which the web of material with the designated workpieces and the plurality of individual tools can be moved incrementally relative to one another in such a way that the web of material can be worked multiple times within one work cycle by means of the plurality of individual tools.

The invention also relates to a method for working, in particular for working without machining, for example for separating and/or forming, a web of material with designated workpieces temporarily held therein, in which the web of material is moved forward incrementally in the machine direction and is worked intermittently multiple times during a work cycle by individual tools.

The invention also relates to a progressive tool for working, in particular for working without machining, for example for separating and/or forming, a web of material, with working stations arranged one behind the other in the machine direction, by means of which working positions of the web of material can be worked successively.

The invention also relates to an individual module for carrying at least one individual tool for working, in particular for working without machining, for example for separating and/or forming, a web of material.

The invention also relates to an arrangement of a plurality of individual modules for carrying individual tools for working, in particular for working without machining, for example for separating and/or forming, a web of material.

The invention also relates to an individual tool of an apparatus for working, in particular for working without machining, for example for separating and/or forming, a web of material.

The invention also relates to a system for working, in particular for working without machining, a web of material, having a production line extending in the machine direction, along which the web of material is incrementally moved forward with individual feed cycles, having a winding device by which the web of material can be unwound from a coil and can be made available for the working process, and having an apparatus for working, in particular for working without machining, for example for separating and/or forming, the web of material, which comprises a plurality of individual tools by means of which a plurality of working positions on the web of material can be worked multiple times during a work cycle between two feed cycles.

The invention also relates to a method for working, in particular for working without machining, for example for separating and/or forming, a web of material, wherein the web of material is moved forward incrementally in the machine direction and is worked intermittently multiple times during a work cycle by individual tools.

In particular, generic apparatuses for working, such as for example for separating and/or forming, a web of material are known from the prior art, for example in the form of a compound tool or a progressive tool.

Such a progressive tool is characterised by a plurality of individual tools by means of which a web of material is worked simultaneously multiple times, the plurality of individual tools being rigidly fixed in the progressive tool. The progressive tool is often held with respect to the web of material by means of a ram device of a press machine, a punching machine or the like, and is repeatedly brought into operative contact with the web of material between two feed cycles, the web of material being worked simultaneously by all of the individual tools.

A disadvantage of such known apparatuses for working a web of material multiple times is, on the one hand, the fixed arrangement of the individual tools, which makes a simple conversion for other products extremely difficult or almost impossible, such that the apparatus is usually completely replaced. On the other hand, it is disadvantageous that the web of material interacts simultaneously with all individual tools during a work cycle, which generally leads to high loads on the apparatus and on the component structures connected thereto.

For example, to ensure that all individual tools of the progressive tool can successfully work the web of material, several tons of pressing force are often required for working a web of material during a work cycle with a progressive tool. However, such enormously high pressing forces not only place a heavy load on the progressive tool in general, but also lead to increased wear on the individual tools in particular, which means that in the course of a production process, due to the increasing wear, quality losses can occur quite soon in the semi-finished product or end product to be produced. This inevitably leads to frequent and/or unscheduled production interruptions with corresponding downtimes in production for additional maintenance and/or repair work. Furthermore, due to the high pressing forces, subframes, such as work tables or the like, and even the foundations of buildings are highly stressed, not least due to a massive repeated shock load due to the operation of the machine equipment.

The object of the invention is to overcome the disadvantages mentioned above. In particular, the invention is based on the object of further developing generic apparatuses and methods in such a way that, on the one hand, longer operating service life in general with regard to such apparatuses and, on the other hand, longer service life for corresponding tools of these apparatuses are achieved, while at the same time reducing rejects caused by bad parts.

The object of the invention is achieved by an apparatus for working, in particular for working without machining, for example for separating and/or forming, a web of material, having a plurality of individual tools for different manners of working the web of material with designated workpieces temporarily held therein, and having a machine direction along which the web of material with the designated workpieces and the plurality of individual tools can be moved incrementally relative to one another in such a way that the web of material can be worked multiple times within one work cycle by means of the plurality of individual tools, wherein the individual tools are designed as individual modules which can be fixed to one another to form an individual module cluster, but can be detached as well.

At least one individual tool is advantageously accommodated in an individual module cluster.

Due to the individual modules fastened to one another, the individual module cluster according to the invention of the apparatus can be easily assembled in a modular manner, and therefore in a structurally very simply and customisable manner. Furthermore, a very high scalability of the apparatus can be achieved in this way.

This is done structurally in a particularly simple manner in that, in accordance with the invention, the individual modules that are now present are detachably connected to one another. Such fixed but detachable connections can be implemented in a variety of designs, as will be explained further below.

The individual module cluster can thus be assembled directly from the individual modules—for example, without the individual modules having to be held together in a master frame of a higher-level machine or the like.

For example, a progressive tool can also be easily assembled from a plurality of individual modules to form an individual module cluster; single individual tools are extremely easy to replace with other individual tools, especially for a product change, because corresponding individual modules can be swapped for other individual modules—optionally in groups.

This is particularly advantageous if the web of material with the plurality of individual tools of the individual module cluster is worked per work cycle, since maintenance work can be significantly shortened—for example, if there is a defect in an individual tool for which the corresponding individual module can be swapped out for another individual module with a new individual tool.

This alone can significantly reduce the proportion of rejects, which means that the apparatus can be operated more cost-effectively.

The situation is similar with regard to set-up or conversion work, which can be carried out significantly more quickly, for example by replacing single individual modules with other individual tools.

When it comes to conversion work, it is often only necessary to deactivate one or two individual tools for the production of a similar product. For example, single individual tools and/or individual modules of the individual module cluster can be moved out temporarily on a side of the individual module cluster facing away from the web of material, such that the corresponding individual tools can no longer interact with the web of material during the work cycle. Cumulatively or alternatively, individual drives and/or drive units can also be deactivated, in particular switched off sequentially, as will be described further below.

In all cases, the operational life of the individual tools and in particular of the individual module cluster can be significantly increased with regard to a product batch.

In the present case, the web of material is worked multiple times by a plurality of individual tools during a single work cycle, and the web of material can be worked multiple times within one work cycle simultaneously with the existing individual tools, or preferably at different times with single individual tools.

As a rule, the web of material advances forward in steps with a feed movement directed in the machine direction, and the web of material remains briefly in a working position for working with the individual tools. However, it is also conceivable that the web of material and individual module cluster are moved together in the machine direction during the working of the web of material by the individual tools, and the individual module cluster is moved counter to the machine direction after working, until the next working position relative to the web of material is reached, and then a new work cycle can begin.

A typical work cycle is characterised, for example, by the fact that designated working positions on the web of material, and thus also the designated workpieces, are usually worked by different individual tools.

In this respect, the term “work cycle” in the context of the present invention describes a time interval that lies between two feed cycles of the apparatus, with a feed cycle being characterised in the present case in that the web of material is displaced in the machine direction with respect to the individual modules and/or the individual module cluster, and thus also with respect to the individual tools. Within the work cycle, the web of material is worked using the individual tools. Once the working of the web of material by the individual tools is complete, the work cycle ends and a new feed cycle can begin.

A feed cycle can be carried out, for example, with a suitable transport drive for the web of material, which transport drive can be assigned to the apparatus, for example in connection with a system for working, in particular for working without machining, a web of material.

Advantageously, the apparatus does not require any gripper devices or the like in order to individually grip the workpieces being manufactured and to transport them forward. Instead, the individual workpieces are transported by means of the web of material, which is moved through the apparatus in the machine direction with the aid of the transport drive—and with it, the designated workpieces that are at least temporarily fixed therein.

In this respect, in the present invention, the designated workpieces are moved and worked together synchronously in the machine direction. For this purpose, the designated workpieces are connected to one another, namely by means of the web of material, and in particular with a residual web matrix of the web of material which remains at the end of the working processes carried out when the workpieces have been separated from the web of material.

It goes without saying that the web of material can be worked in a wide variety of ways within the meaning of the invention in order to produce corresponding workpieces on the web of material.

For example, with a corresponding design of the individual tools, machining processes, for example with or without a geometrically defined cutting edge, can be employed. For example, an individual tool can include a 3-axis milling and drilling tool or the like.

The present working without machining differs from machining working methods in that no or only a negligibly small subtraction of material is carried out on a block of material—compared to, for example, turning, milling or the like.

The present working without machining, on the other hand, is characterised in that substantially only forming and/or separating processes are carried out on a web of material.

In the context of the invention, the term “separating” describes a separating process on the web of material with a separating tool. In the present case, the term “separating” comprises in particular material working such as cutting, in particular lasering, punching, sawing, tearing or the like.

For example, the web of material can be perforated, in particular at its edges, for movement by rotation, wherein the web of material can be transported and/or realigned, in particular in conjunction with the perforations, by means of positive and/or non-positive engagement.

For the purposes of the invention, the term “forming” describes any plastic and/or elastic forming operations on the web of material, such as bending, deep-drawing, pressing, forging, hydroforming, rolling or the like.

For example, individual tools, such as rotary punches, for example having a plurality of pairs of rollers, punches, and/or rolls, can be created and used, wherein the number of pairs of rollers is preferably chosen such that there are no or only negligible oscillating masses. As a result, particularly high speeds can then be achieved for the web of material.

As such, the individual tools can preferably also be corresponding tools for separating and/or forming or the like.

However, other working methods without machining, including, for example, primary shaping processes such as casting, in particular casting around the web of material, at least partially, such as casting around areas of the web of material that have already been worked beforehand, can be used particularly advantageously in the present case by means of appropriately designed individual tools. For example, sintering processes or the like, or additive and/or generative processes using such individual tools can also be made possible within the scope of the present invention.

Furthermore, for example, joining processes such as welding, soldering, gluing or the like, or for example coating processes such as painting, powder coating or the like, and/or processes that change material properties, such as hardening, annealing or the like, in particular by induction, can also be carried out particularly advantageously using appropriately designed individual tools.

Within the meaning of the invention, the term “individual tool” designates an active part integrated into an individual module, by means of which the web of material can be worked.

An individual tool is typically also referred to as a single tool in the prior art; however, known single tools cannot be brought into operative contact individually independently of one another, i.e., selectively, with the web of material during a work cycle, as is the case in the present invention—they can only work together. This is substantially also due to the fact that the single tools have hitherto been held stationarily and/or rigidly in a support structure.

In the present case, the individual tools can also be activated individually or in groups.

By way of example, however, the individual tools can be held in a support structure so that they can be moved relative to one another, with the support structure being formed by the plurality of individual modules connected to one another.

For example, an apparatus equipped within the meaning of the invention, such as a progressive tool, has a plurality of such individual tools, by means of which working positions of a web of material are successively worked by means of a plurality of work cycles, and these individual tools are provided and/or arranged in the available individual modules, and as such are no longer inseparably integrated together in a single higher-level tool or the like.

The term “web of material” in the present case describes a strip-shaped or belt-shaped semi-finished product in the form of a strip product. The web of material can be a continuous product or a readymade product. As such, the web of material can be provided as strip cuts, individual cuts, and in particular as ready-cut strip webs of, for example, 4 m, 6 m, 10 m or the like.

In the context of the invention, the web of material is converted in the course of working into a web of material with workpieces held therein.

The web of material thus temporarily has a plurality of workpieces to be produced, which are held on the web of material, while the web of material with the workpieces fixed therein, and/or the workpieces fixed on the web of material, is and/or are successively worked along the production line.

In this respect, the web of material is characterised during working by a group of workpieces which are held on the web of material.

The workpieces to be produced thus remain integrated into the web of material until the final separation.

In other words, it can be said that the web of material is subdivided in the course of working into a plurality of workpieces to be produced and into a residual web matrix, with the plurality of workpieces being fixed in the residual web matrix. At the end of the working process, the plurality of workpieces are separated from the residual web matrix.

At this point it should be pointed out that statements regarding “working the web of material”, in whatever form, always also imply working workpieces that have already been produced and are held and/or fixed in the web of material, to the extension that workpieces have already been formed on the web of material by a first work step.

The web of material extends without interruption in this case through at least two individual modules, preferably through a plurality of individual modules, and particularly preferably through all individual modules.

It should also be pointed out that indefinite articles and indefinite numbers such as “one . . . ”, “two . . . ” etc. should generally be understood as minimum information, i.e., as “at least one . . . ”, “at least two . . . ” etc.—unless it follows from the context or the concrete text of a certain passage that only “exactly one . . . ”, “exactly two . . . ” etc. is the intended meaning.

At this point, it should also be mentioned that within the scope of the present application, the expression “in particular” should always be understood in such a way that an optional, preferred feature is introduced with this expression. The expression is not to be construed as “specifically” or “solely”.

The object of the invention is also achieved by an apparatus for working, in particular for working without machining, for example for separating and/or forming, a web of material with designated workpieces temporarily held therein, having a plurality of individual tools for different manners of working the web of material, and having a machine direction along which the web of material with the designated workpieces and the plurality of individual tools can be moved incrementally relative to one another in such a way that the web of material can be worked multiple times within one work cycle by means of the plurality of individual tools, the individual tools being designed as individual modules of an individual module cluster driven autonomously by a motor.

If the individual modules are equipped to be driven autonomously by a motor, then in particular individual tools of the individual modules can be activated and operated during a work cycle in a structurally and procedurally simple manner, in particular independently of one another, such that during the work cycle, with regard to the existing individual tools, for example any work sequences for working the web of material and the workpieces fixed therein can be produced.

For example, critical load peaks occurring in the apparatus due to work forces can ideally be completely prevented, or at least greatly reduced, which in turn can significantly increase the service life of the individual tools, and accordingly can also increase the operational life of the apparatus in general.

As a result of the associated reduced tool load, the proportion of rejects can also be significantly reduced, as a result of which the apparatus can be operated more cost-effectively.

Furthermore, existing individual tools can be individually activated and/or deactivated during a work cycle by means of the autonomously motor-driven individual modules, whether in and/or transverse to the machine direction, such that the effects and advantages already described above can be achieved in terms of design and process technology.

The term “autonomously motor-driven” in the context of the invention describes the fact that the respective individual modules, and thus also the relevant individual tools, have their own functional and/or drive unit which can be activated and/or deactivated independently of other individual modules.

Such functional and/or drive units designed in accordance with the invention can be equipped in a wide variety of ways.

For example, such a functional and/or drive unit comprises a rotary or linear drive in order to activate a separating and/or forming tool, for example.

For example, an alternative functional and/or drive unit comprises a radiation-emitting source or the like. A light-emitting source for activating and/or generating a laser for cutting, hardening or the like is mentioned here only as an example.

In this respect, the term “motor-driven” in the context of the invention comprises in particular any device for activating and/or operating an individual tool, in particular in contrast to manually operated tools.

As a result, the individual modules each have an individual drive, as a result of which the individual modules, in the machine direction and/or transverse to the machine direction, are independent of a higher-level, shared machine drive, for example a ram drive of a press drive.

In this respect, in the context of the present invention, the total drive power of a hitherto single machine drive for working a web of material is divided among a plurality of individual drive powers of many individual drives for working the web of material.

As a result, the overall drive power of individual tools for working the web of material can advantageously be increased for the same machine size, or can be reduced for a reduced machine size.

In other words, this means that the individual tools are driven in a decentralised manner by a plurality of individual drives. This is a departure from a previously conventional central drive, for example by means of a press motor or the like.

The reorientation towards individual drives, for example based on autonomously operating drive units, also has a positive effect on the required power input. This power input can be reduced because a conventional power-intensive central drive is no longer required.

The object of the invention is achieved by an apparatus for working, in particular for working without machining, for example for separating and/or forming, a web of material, having a plurality of individual tools for different manners of working the web of material with designated workpieces temporarily held therein, and having a machine direction along which the web of material with the designated workpieces and the plurality of individual tools can be moved incrementally relative to one another in such a way that the web of material can be worked multiple times within one work cycle by means of the plurality of individual tools, wherein the individual tools are designed as individual modules with a distance measurement device for controlling and/or regulating each individual tool.

If the individual modules each have a distance measurement device for controlling and/or regulating each of the individual tools, then the individual tools can be moved with particular precision with respect to the web of material.

In particular, the individual tools can be positioned independently of one another with respect to the web of material. In other words, this means that the individual tools can be moved and positioned extremely precisely with respect to the web of material depending on and/or as a function of tool wear, hardness of regions of the web of material, or the like.

Due to the individual and precise positioning of the individual tools, the apparatus can be operated in a more wear-optimised manner, such that on the one hand its operational life and on the other hand in particular the service life of the individual tools can be significantly increased, with a simultaneous reduction in the proportion of rejects.

It goes without saying that suitable distance measurement devices can be provided in a variety of ways. For example, the distance measurement device can include different sensors, by means of which a distance measurement can be performed directly on a drive for the individual tools, or alternatively or cumulatively, a distance measurement can be performed directly on the individual tool.

At this point it should be mentioned that the present apparatus is advantageously configured to move workpieces to be produced using the web of material in the machine direction, in particular along a production line, such that additional gripper devices or the like for transporting individual workpieces between the individual modules—as are used, for example, with transfer presses, automatic forming machines or the like—can be dispensed with.

In this respect, the present apparatus can also advantageously be used to provide a progressive tool, as will be described further below.

In an advantageous variant, a plurality of individual modules are arranged together in a column and row arrangement, with the column arrangement extending in one or more columns in the machine direction and the row arrangement extending in two or more rows transverse to the machine direction. As a result, an arrangement matrix of almost any design can be generated for an individual module cluster from individual modules with a wide variety of individual tools.

In this respect, it is advantageous if the individual modules are fixed but detachably arranged to form at least one column unit and/or at least one row unit, with one row unit in particular forming a working station, wherein a plurality of working stations are arranged one behind the other in the machine direction. As a result, the very different working stations can not only be individually implemented in terms of design, but also very easily connected to one another.

In this context, it is expedient if the apparatus has working stations arranged one behind the other in the machine direction, with one working station consisting of at least one individual module. As already mentioned, a web of material can be worked incrementally in multiple ways as a result.

In this case, the column unit runs in the machine direction, and the row unit runs transverse to the machine direction.

In any case, individual modules can be variably arranged in a fixed by detachable manner in columns and rows to form an individual module cluster.

For example, a simple individual module cluster consists of a plurality of individual module clusters arranged one behind the other in the machine direction.

In any case, it is particularly expedient if an individual module cluster made up of individual modules is self-supporting. As a result, the individual module cluster and thus also the working apparatus can be implemented in a structurally particularly simple and compact manner.

The individual module cluster preferably has a self-supporting base body which is composed of individual modules, as a result of which the construction can be further simplified. As a result, additional rack and/or frame parts or the like can be dispensed with.

The individual modules can be detachably fixed to one another in the manner of a matrix, either individually or in groups.

A particularly preferred variant provides that the apparatus has an arrangement matrix in which the individual modules can be arranged to form an individual module cluster. By means of this arrangement matrix, individual tools can be placed with respect to each other in a structurally simple manner in almost any way.

The arrangement matrix can have a variety of configurations, preferably at least one column in the machine direction and at least one row transverse to the machine direction.

In this case, the arrangement matrix extends in a matrix plane which is created on the apparatus by a plurality of individual modules which are connected to one another.

In this case, the arrangement matrix can be constructed in a structurally particularly simple manner by means of a frame composed of individual modules. However, the matrix arrangement can also include one or more auxiliary frames for holding individual modules or the individual module cluster.

If individual modules can be inserted and/or removed from at least two different sides, in particular two opposite sides, in the arrangement matrix, in particular in the individual module cluster, the assembly of individual modules can be significantly simplified, in particular with regard to an exchange of single individual modules of an already operational individual module cluster, even if the individual module cluster is properly installed in the apparatus.

For example, individual modules can be inserted and/or removed both individually and in groups, in particular while directly or indirectly adjacent individual modules are arranged in their respective final assembly positions.

The individual modules can be assembled and/or disassembled easily if the arrangement matrix has slots for accommodating the individual modules.

A very advantageous variant provides that slots are directly delimited by one or more surrounding individual modules.

If a slot has a mounting dimension that is the same as or larger than the external dimensions of an individual module, individual modules can be reliably inserted and/or removed from such slots.

The arrangement matrix can be provided on the apparatus in a structurally very simple manner if the arrangement matrix has a self-supporting base body which is formed by means of the individual modules.

Furthermore, it is advantageous if the arrangement matrix has a plurality of frame parts, in particular subframe parts, with each individual module preferably being assigned a frame part by means of the arrangement matrix.

By means of the frame parts, for example, forces and/or moments introduced into the apparatus by means of the individual modules can be well absorbed and dissipated, for example, into a frame foundation or the like. Or such frame parts can be used to arrange and/or hold other components.

Frame parts of this type can be implemented as an individual frame part for an individual module or as a group frame part for a plurality of individual modules.

The individual module cluster can be designed with even more variants in terms of its structure if an individual module cluster comprises both individual modules having individual tools and empty modules. This allows any individual module cluster to be generated, for example with regions that are completely free of individual tools.

As already described at the outset, motor-driven individual modules are advantageous, and such motor-driven individual modules can be implemented in a structurally simple manner if the individual modules each have an autonomously operating functional and/or drive unit.

This means that in the present case individual tools from individual modules are not driven centrally by means of a central functional and/or drive unit, but rather individually by respective autonomously operating functional and/or drive units, in the manner of individual drives which are arranged in a decentralised manner on the respective individual modules.

In this case, the individual modules can be driven individually and autonomously, preferably in the machine direction and/or transverse to the machine direction.

Each autonomously operating functional and/or drive unit can be configured differently, for example with a motor which is operatively connected to each of the individual tools by means of a transmission unit in order to be able to leverage drive forces, for example.

If the autonomously operating functional and/or drive unit has a direct drive, the individual module can be made more compact.

For example, each of the autonomously operating functional and/or drive units comprise a purely electrically operating motor, for example a servo-electromechanical motor.

In order to be able to apply even higher work forces in a structurally simple manner without an additional transmission unit, a preferred embodiment provides that the direct drive comprises a servo-hydrostatic motor.

Such a direct drive configured on the individual module comprises, for example, an electrically operated servo motor that drives a hydraulic pump. This hydraulic pump can preferably be a valveless pump, such that components that are more susceptible to wear, such as valves, can be dispensed with.

In particular, servo-hydrostatic motors are characterised by very high movement and positioning accuracy, and therefore work with high precision and are also very low-maintenance.

With servo-hydrostatic motors, with regard to the working strokes of the autonomously operating functional and/or drive units, stroke rates of currently up to 250 strokes per minute are easily possible. Supplementary and/or alternative autonomous functional and/or drive units can allow for up to 4000 strokes per minute, for example drives comprising toggle levers, or up to 8000 strokes per minute, such as drives comprising crankshafts, or even up to 10,000 strokes per minute, such as in particular drives comprising camshafts.

Alternatively, however, a transmission unit can be provided, for example in order to actuate a plurality of individual tools of a group of individual modules together, if the apparatus is suitably configured.

If each of the autonomously operating functional and/or drive units can be arranged on the individual module in any position, the degree of freedom of design options can advantageously be further increased. For example, individual modules are linked to one another in such a way that functional and/or drive units of the individual modules are arranged on different sides of the apparatus, for example on opposite sides with respect to a production line.

With a suitable arrangement of autonomously operating functional and/or drive units, forces and/or moments temporarily acting on the apparatus, for example of two individual modules working the web of material at the same time, can mutually neutralise or at least reduce one another.

In particular, lines of force acting on the apparatus can be arranged in such a way that forces at least partially cancel each other out, or forces act mainly only in structural areas of the apparatus that are designed to be reinforced for this purpose.

Furthermore, it is advantageous if the autonomously operating functional and/or drive unit can be controlled and regulated according to a distance measurement device of the individual module. As a result, the individual tools can interact individually and thus particularly precisely with the web of material being worked.

The measured values of the distance measurement device can serve excellently as a basis and/or feedback for controlling and/or regulating the autonomously operating functional and/or drive unit.

Furthermore, this also allows a “self-optimised system” to be provided on the apparatus, as is also explained in more detail below.

The property of the “self-optimising system” arises in particular substantially through inspection, preferably 100% inspection, of working positions of the web of material, in particular of workpieces, in the working process, for example by means of suitable measuring devices which are assigned to individual tools, for example. For example, fluctuations in the degree of hardness and/or fluctuations in the material thickness can be detected, and the working process can be modified accordingly.

Tests of geometric product specifications or the like, for example of the workpiece, initiated as a result are significant differences from machines in which only the tools are monitored for position and travel path.

All of this contributes to the fact that, in the present case, an individual module in particular can optimise itself, as a result of which, for example, fluctuations in the degree of hardness and/or fluctuations in the material thickness can be compensated for.

The method of moving a tool to the end stop for calibration, which is known from practice, can be omitted in the present case.

The integrated distance measurement device also advantageously makes it possible to react directly to changing conditions, such as stronger springback a region of the web of material bends, and to move the individual tool of the individual module in question individually in such a way that the required final dimension is achieved at the working position of the web of material.

A particularly precise control and/or regulation of the autonomously operating drive units and/or the individual tools driven thereby can be achieved if the distance measurement device and/or components thereof is integrated into the given autonomously operating functional and/or drive unit.

Cumulatively or alternatively, it is advantageous if each of the autonomously operating functional and/or drive unit can be controlled and regulated as a function of a hardness of a material region of the web of material. This also allows the individual tools to interact individually and thus particularly precisely with the web of material to be worked.

This also makes it very easy to provide a “self-optimised system” in the apparatus, as is also explained in more detail below.

A positioning accuracy of 0.01 mm is possible by means of the present distance measurement device, particularly with regard to the individual tools, and specifically with repeat accuracy.

In particular, a dynamic force/displacement control loop made possible by means of the autonomously operating functional and/or drive unit also has an advantageous effect, since this enables “silent operation” in which the noise output during operation can be reduced to below 70 dB.

For example, an advantageous operating mode can be selected in the present case in which the individual tool is first gently placed on the web of material and/or the individual tool is additionally braked shortly before a material breakthrough on the web of material with regard to its movement relative to the web of material.

The respective autonomously operating functional and/or drive units can be controlled and regulated as a function of the forces and/or moments acting on the apparatus. As a result, not only can the web of material be worked more gently, but in particular also other structural components of the present working apparatus and/or building floors and/or foundations thereof can be protected.

It is also advantageous if the individual modules each have a receiving device by means of which an autonomously operating functional and/or drive unit can be arranged on the individual module, as a result of which the individual module can be built very compactly despite an individually operable integrated individual tool.

At this point it should also be pointed out that with conventional working machines, such as a progressive press or the like, the main direction of action of the working axes is only aligned at a 90° angle to a workpiece.

In the present case, however, working axes of individual tools can also be aligned with a different functional direction and/or main direction of action with respect to the web of material and/or its working positions and/or with respect to workpieces held in the web of material; i.e., it can have a main direction of action that is different from a direction orthogonal to the plane of the web of material. As a result, the web of material can be worked in a variety of ways, in particular with regard to workpieces fixed therein.

In this respect it is advantageous if an autonomously operating functional and/or drive unit of the individual module has at least one main direction of action relative to the web of material which deviates from an orthogonally aligned direction of action relative to the web of material.

In addition, it is advantageous if a distance measurement device for controlling and/or regulating an autonomously operating functional and/or drive unit and/or an individual tool is integrated on a direct drive of the individual module. On the one hand, such an integration allows the entire apparatus to be built in an extremely compact manner. On the other hand, the individual tool can be operated extremely precisely with regard to the web of material.

In order to be able to actuate the individual tools individually or in groups within the meaning of the present invention, a particularly expedient variant provides that the apparatus has a control and/or regulating device for activating autonomously operating functional and/or drive units of the individual modules, by means of which the autonomously operating functional and/or drive units can each be activated individually, in particular during the work cycle.

Advantageously, the individual tools are each operationally connected by means of the autonomously operating functional and/or drive units to the control and/or regulating devices, such that individual tools can be sequentially actuated and controlled by means of the control and/or regulating device.

By means of the present control device, according to the invention, the autonomously operating functional and/or drive units can be actuated and controlled, whereas, by means of the present regulating device, the autonomously operating functional and/or drive units can be individually regulated in response to other process influences.

For the purposes of the present invention, however, the terms “control” and “regulate” are used synonymously.

It is conceivable in this case to create a digital twin for the present apparatus, in particular by means of the present control and/or regulating device, in order to be able to possibly achieve a computer-aided simulation, in particular a “real-time capable” process mapping.

The individual modules can also be constructed in the most varied of ways in order ideally to be able to accommodate both at least one individual tool and an autonomously operating functional and/or drive unit for the individual tool.

A further advantageous embodiment variant of the invention provides that the individual module has a frame part which can be detachably fixed to a further frame part of at least one further individual module, wherein an individual module cluster can be produced by means of frame parts of the individual modules connected to one another.

In this case, the individual module can be provided in a particularly stable manner if the individual module has an envelope with a receiving space for receiving at least one individual tool.

Such a receiving space can in turn be structurally surrounded by the frame part, with the at least one individual tool being arranged at least partially in the frame part of the individual module, and with the individual modules being able to be operatively connected to one another in a fixed but detachable manner to form an individual module cluster.

The individual modules can be directly connected to one another and fixed to one another if the individual modules have mutually corresponding coupling devices.

In this respect, it is also advantageous if the frame part has a coupling device by means of which individual modules can be operatively connected to one another, since external connecting devices can be dispensed with in this case.

In this context, it is advantageous if the coupling device has coupling elements which are preferably arranged on all four sides of the frame part, the coupling elements acting in particular in a positive and/or non-positive manner. By means of such versatilely arranged coupling elements, the individual modules can be detachably connected to one another in any manner with regard to their sides running between the head sides.

Such coupling elements can be realised in many different ways within the meaning of the invention. Clamp, bracing, screw, snap-in, click and plug-in connections are listed here solely as examples.

The head sides of the individual module are preferably designed as short sides, and the sides lying in between are designed as long sides in comparison, as a result of which longer working strokes can be executed between the head sides during the work cycle.

The individual module can be designed to be particularly dimensionally stable during the work cycle, particularly with regard to the forces occurring, if the frame part has opposite end plate parts, the opposite end plate parts being arranged spaced apart from one another by column parts.

If a first end plate part of the two end plate parts has a receiving device for an autonomously operating functional and/or drive unit, and a second end plate part of the two end plate parts has a contact surface of a frame part, then forces generated on the individual module during the work cycle can be advantageously dissipated into the frame part by means of the autonomously operating functional and/or drive unit.

With regard to an expediently refined embodiment variant, individual modules are connected to one another to form a common upper tool of the apparatus, as a result of which the upper tool can be equipped in a modular manner with individual tools that can be controlled individually during a work cycle.

In this respect, it is advantageous if the common upper tool of the apparatus is formed by individual modules comprising a plurality of individual tools. As a result, the upper tool which works a web of material intermittently, can be assembled in an individualised manner.

In this case, the upper tool is advantageously composed of individual modules in a modular manner.

In addition, it is advantageous if frame parts are connected to one another to form a common lower tool of the apparatus.

With such individual modules and such corresponding frame parts, the web of material can be worked incrementally without any problems, and an apparatus equipped in this way can be easily retrofitted in existing systems.

A particularly advantageous variant provides that the apparatus is configured to carry out working processes on the web of material, in particular on workpieces of the web of material, in a state of a self-optimising system. For example, this is achieved by inspecting the “workpiece” during the working process.

Such self-optimisation can be performed taking into account properties of the web of material and/or of the workpieces thereof, for example according to the geometry of a designated workpiece, material properties of a designated workpiece, one or more previous and/or one or more subsequent working states and/or working processes, or the like.

For example, information (degree of hardness, material thickness, tribology, material characteristic data, or the like) which influences the web of material, in particular designated workpieces thereof, is taken into account—in addition or as an alternative.

Only one example is mentioned here as representative of a self-optimised working process in the present apparatus, namely with regard to different degrees of hardness in a web of material. Regions with different degrees of hardness arise in a web of material wound into a coil during the production (rolling process) of the material, as a result of manufacturing processes. These different degrees of hardness influence the spring-back properties of the material, for example. In order to be able to take these different degrees of hardness into account in the present working process, suitable measuring devices, by means of which these changes and/or differences are measured, are integrated into the individual tools. For example, a forming process (bending, embossing or the like) can be modified by a feedback loop or a plurality thereof in the respective individual modules and/or in a corresponding station of a functional and/or drive unit, in particular at least one axis thereof. This enables an almost reject-free process.

It goes without saying that similar self-optimised working processes can also be carried out, in addition or as an alternative, using other information if the apparatus is equipped and/or supplied with appropriate measuring devices and/or data.

As already explained above, a self-optimising system can be ensured particularly well in the present case substantially by inspection, preferably 100% inspection, of working positions of the web of material, in particular of workpieces in the web of material, during the working process. To this end, it is expedient if the apparatus is equipped with suitable measuring devices, preferably in the individual tools and/or the individual modules.

Tests of geometric product specifications or the like of the workpiece initiated accordingly are significant differences from machines in which only the tools are monitored for position and travel path.

All of this contributes to the fact that, in the present case, in particular an individual module and/or an individual tool arranged on it can optimise itself, as a result of which, for example, fluctuations in the degree of hardness can be compensated for.

In addition, this also applies to other processes in the present apparatus.

Suitable measuring devices for this purpose are known and can be designed in a variety of ways, and are therefore not explicitly explained in more detail.

The object of the invention is also achieved by a progressive tool for working without machining, in particular for separating and/or forming, a web of material, with working stations arranged one behind the other in the machine direction, by means of which progressive tool working positions of the web of material can be worked successively, the progressive tool having an apparatus according to any of the features described above.

The working of webs of material can be further developed particularly effectively by means of such a progressive tool.

The working positions of the web of material embody individual designated workpieces in the web of material, these workpieces being connected to one another by means of the web of material.

At this point it should be claimed that the progressive tool described above can be supplemented by further technical features described here in order to advantageously further develop the progressive tool.

The same is true with regard to similar apparatuses, such as with regard to a progressive tool, a progressive cutting tool, or the like.

The object of the invention is also achieved by an individual module for carrying at least one individual tool for working, in particular for working without machining, for example for separating and/or forming, a web of material with designated workpieces temporarily held therein, the individual module having a working path along which the web of material can be transported incrementally in the machine direction, and/or a coupling device with coupling elements for a fixed but detachable coupling to at least one further individual module, and/or an autonomously operating functional and/or drive unit for directly driving the at least one individual tool with respect to the working path, and/or a distance measurement device for controlling and/or regulating the autonomously operating functional and/or drive unit and/or the at least one individual tool.

The working of webs of material can be further developed particularly effectively by means of such an individual module.

A very advantageous further development provides that the individual module comprises machining and/or non-machining individual tools, in particular primary shaping, forming, separating, joining, coating, material-property-changing individual tools or the like. This means that individual modules can be equipped with even more individual customisation.

At this point, it should also be claimed that the individual module described above can also be supplemented by further technical features described here in order to advantageously further develop the individual module.

The object of the invention is also achieved by an arrangement of a plurality of individual modules for carrying individual tools for working, in particular for working without machining, for example for separating and/or forming, a web of material with designated workpieces temporarily held therein, the individual modules being operatively connected to one another to form an individual module cluster.

The working of webs of material can be further developed particularly effectively by means of such an arrangement.

At this point, it should also be claimed that the arrangement described above can be supplemented by further technical features described here in order to advantageously further develop the arrangement.

The object of the invention is also achieved by an individual tool of an apparatus for working, in particular for working without machining, for example for separating and/or forming, a web of material, in particular of a progressive tool, wherein the individual tool has an individual module for generating an individual module cluster, in particular an individual module according to any of the features described here.

The working of webs of material can be further developed particularly effectively by means of such an individual tool.

At this point, it should also be claimed that the individual tool described above can be supplemented by further technical features described here in order to advantageously further develop it.

Furthermore, a changing apparatus for the automated or semi-automated insertion and/or removal of individual modules having individual tools into/from an individual module cluster, in particular into/from an arrangement matrix, in an apparatus for working, in particular for working without machining, a web of material, or in a progressive tool, having a manipulator device for gripping and guiding individual modules, is advantageous.

Individual modules can advantageously be exchanged by means of the changing device. Even solely in this way, the present working apparatus in particular can be advantageously further developed, such that the combination of features is advantageous with regard to the changing apparatus without the other features of the invention.

Furthermore, it should also be claimed that this individual tool changing apparatus can be supplemented by further technical features described here in order to advantageously further develop the changing apparatus.

The object of the invention is also achieved by a system for working, in particular for working without machining, a web of material, having a production line extending in the machine direction, along which the web of material is incrementally moved forward with individual feed cycles, having a winding device from which the web of material can be unwound from a coil and made available for the working process, and having an apparatus for working, in particular for working without machining, for example for separating and/or forming, the web of material, which comprises a plurality of individual tools, by means of which a plurality of working positions on the web of material can be worked multiple times during a work cycle between two feed cycles, the system being characterised by an apparatus according to any of the features described here.

As a result, products can be produced from strip material much more effectively and with the greatest precision.

A further development or alternative can be created in that the present system is characterised, in addition or as an alternative, by the present progressive tool or by the present individual module or by the present arrangement of a plurality of individual modules or by the present individual tool.

Furthermore, the system can have a separating device for cutting the web of material into pre-cut material web segments and/or for separating pre-cut material web segments, by means of which a continuous strip material can be segmented.

The object of the invention is achieved, in terms of process, by a method for working, in particular for working without machining, for example for separating and/or forming, a web of material with designated workpieces temporarily held therein, in which the web of material is moved forward incrementally in the machine direction, and is intermittently worked multiple times by individual tools during a work cycle, wherein the total drive power for working the web of material using the individual tools is divided into a plurality of individual drive powers during the work cycle.

Due to the plurality of individual drive powers for driving autonomously operating functional and/or drive units of the individual tools, forces occurring during a work cycle can be controlled much better, for example on an apparatus for working the web of material.

In this way, critical load peaks that occur can ideally be completely prevented or at least greatly reduced, which in turn can significantly increase the service life of the individual tools, and accordingly can also increase the operational life with regard to the apparatus for carrying out the method.

The associated load reduction can also significantly reduce the proportion of rejects in terms of bad parts produced, as a result of which production can be carried out more efficiently and cost-effectively using the present method.

The term “intermittently” in the context of the invention describes a method step between two feed cycles, in which method step the individual tools are brought into operative contact with the web of material in order to work the web of material multiple times during the work cycle with regard to a plurality of working positions.

For example, when the method is carried out accordingly, the required power consumption of the apparatus can be significantly reduced if, for example, individual modules are operated individually and sequentially—in particular in rapid succession. As a result, a maximum “peak power consumption” can advantageously be significantly reduced.

The object of the invention is also achieved, in terms of process, by a method for working, in particular for working without machining, for example for separating and/or forming, a web of material with designated workpieces temporarily held therein, in which the web of material moves forward incrementally in the machine direction, and is intermittently worked multiple times by individual tools during a work cycle, wherein more than one working stroke, with regard to the individual tools, for working the web of material takes place during the work cycle.

In contrast to previous methods for working a web of material, in particular by means of a known progressive tool, in which all individual tools are moved together with respect to the web of material by means of one working stroke, in the context of the present invention the individual tools are moved with respect to the web of material in particular with a plurality of working strokes. More precisely, each individual tool is preferably moved with its own working stroke.

In this way, critical load peaks that occur can ideally be completely prevented or at least greatly reduced, which in turn can significantly increase the service life of the individual tools, and accordingly can also increase the operational life with regard to the apparatus for carrying out the method.

The associated load reduction can also significantly reduce the proportion of rejects in terms of bad parts produced, as a result of which production can be carried out more efficiently and cost-effectively using the present method.

The object of the invention is also achieved, in terms of process by a method for working, in particular for working without machining, for example for separating and/or forming, a web of material with designated workpieces temporarily held therein, in which the web of material is moved forward incrementally in the machine direction, and is intermittently worked multiple times by individual tools during a work cycle, wherein the individual tools are activated and/or driven or operated in a decentralised manner during this work cycle.

In this case, the individual tools are advantageously operated and/or driven individually, as a result of which the individual tools can work more precisely on the web of material.

In this way, any critical load peaks that occur can ideally be completely prevent or at least greatly reduced, which in turn can significantly increase the service life of the individual tools, and accordingly can also increase the operational life with regard to the apparatus for carrying out the method.

The associated load reduction can also significantly reduce the proportion of rejects in terms of bad parts produced, as a result of which production can be carried out more efficiently and cost-effectively using the present method.

At this point it should be noted that all the claimed methods have in common an individual actuation of individual tools, be it individually or in groups during a work cycle, and this approach is in contrast to the previously conventional special methods for working webs of material without machining, in which during a work cycle all individual tools are actuated simultaneously with a single working stroke.

In any case, the total amount of energy required for working the web of material can be significantly reduced compared to conventional methods, since the force required for working the web of material is concentrated only on the individual working positions, and the required total energy expenditure can be reduced in this respect.

In addition, it is possible in the present case to dynamically regulate the working of the web of material during a work cycle as a function of a wide variety of process parameters, in particular by means of the individual drives. In other words, this means that subregions of the present apparatus can be adjusted individually and/or dynamically and independently of one another during operation, in particular during a work cycle.

This is not possible with conventional working methods, since up to now a compound tool, in particular a progressive cutting tool and/or a progressive tool, or the like, has been operated as a rigid unit with a central drive, such that it cannot be independently adjusted in subregions during operation. Dynamic control, as in the case of the present invention, has not previously been possible.

If workpieces connected to one another by the web of material are moved along a production line in the machine direction by means of this web of material, a plurality of working processes can be carried out at a plurality of working positions on a single web of material.

It is advantageous if the individual tools are actuated sequentially during the work cycle individually and/or in groups, in particular in multiple working stations. As a result, the individual tools can come into operative contact with the web of material during a single work cycle, advantageously individually or optionally in groups sequentially, as a result of which the web of material on the one hand and the working apparatus with which the method is carried out on the other hand are less heavily loaded by working forces and/or working moments.

It is also accordingly expedient if the individual tools work the web of material sequentially during the work cycle individually and/or in groups, as a result of which each of the working processes carried out by an individual tool can be carried out more precisely.

Ideally, up to 100% measurement is possible in suitable operating modes with appropriately coordinated control and readjustment of the axis. This option generates a first pass yield (FPY) of up to 99%, in particular by recording power consumption data, and gives an indication of changing parameters, such as wear, degree of hardness, geometric changes, etc. Such parameter and variable detections made possible by appropriate measurement techniques can advantageously also be one of the key factors for a real-time mapping of operating modes of the present apparatus.

It is also advantageous if fewer work steps are carried out on the web of material by means of the individual tools during the work cycle per working stroke than there are overall individual tools. In this way, too, the web of material and the working apparatus carrying out the method can be subjected to differentiated working forces and/or working moments.

It is also expedient if different autonomously operating functional and/or drive units are activated during the work cycle per working stroke relative to the web of material. As a result, the individual tools can be actuated individually and interact with the web of material much more precisely than would be the case with a single common working stroke for all individual tools.

A variant of the method provides, for example, that during the work cycle one or more individual tools arranged downstream in the machine direction are actuated before or after one or more individual tools arranged upstream, or vice-versa. In this case, the web of material can be worked even more individually.

If, during the work cycle, the order in which individual tools are actuated for working the web of material is selected as a function of the intensity of the designated working forces of each of the individual tools, a local concentration of load peaks can be avoided.

If, in addition or as an alternative during the work cycle, the sequence of actuation of individual tools for working the web of material is selected as a function of the location at which the designated working forces of each of the individual tools are applied, a local concentration of load peaks can also be avoided.

It is also advantageous if, during the work cycle, the sequence in which individual tools are actuated for working the web of material is selected as a function of the designated force load distribution on the web of material and/or on the frame parts supporting the web of material. This also makes it possible to avoid a local concentration of load peaks.

Similar results are obtained if, during the work cycle, the individual tools are actuated as a function of calculated, simulated and/or actual deformations of a component or a component group, in particular of frame parts supporting the web of material of an apparatus for working the web of material without machining.

A further advantageous variant of the method provides that, during the work cycle, autonomously operating functional and/or drive units actuate the individual tools in real time as a function of measurement data from a measuring device.

This measuring device is preferably integrated into an autonomously operating functional and/or drive unit for actuating an individual tool assigned to this drive unit, such that a correction can take place almost without delay.

In this way, each of the individual tools can advantageously be activated in real time, and each of the working processes can be carried out extremely precisely.

The method can be positively further developed if, during the work cycle, autonomously operating functional and/or drive units for actuating the individual tools are operated with a stroke rate of working strokes of more than 500/min or more than 1000/min, preferably more than 3000/min, and less than 5000/min, preferably less than 4000/min. As a result, the output can be significantly increased, which means that even more effective production is possible.

A further advantageous variant of the method provides that the individual tools are driven by autonomously operating functional and/or drive units arranged on individual modules, with each individual module being assigned an autonomously operating functional and/or drive unit. As a result, each individual tool can be operated without a delay.

A further preferred variant of the method provides that the web of material with the designated workpieces held therein at least temporarily is worked as a function of a monitoring of individual tools and of the web of material, in particular of workpieces arranged therein, in order to be able to carry out working processes in a self-optimised manner.

Self-optimisation within the meaning of the present invention can take place particularly well if the following three actions are carried out repeatedly as a result of the interaction, in particular, of individual tools and workpieces of the web of material:
1. Analysis of current situations
2. Determination of process goals
3. Customisation of working behaviour

It is particularly advantageous for the present self-optimisation if desired goals and/or working processes are determined or adapted depending on the situation.

In this respect, the present working method and/or the products produced thereby can be further improved if, in particular, variables and/or information which are influenced by the web of material at the individual working positions and/or by workpieces on the web of material are taken into account.

For example, the variables “degree of hardness, material strength, tribology, material characteristics” etc. determine the yield of a process and/or the working method.

In this respect, in particular by inspecting the “workpiece” during the working process, a state of a self-optimising system can be achieved.

In this respect, it is advantageous if, in the case of the present working process, both information about the tool and information about the workpiece is incorporated into the production process and taken into account, such that corresponding self-optimised open-loop and closed-loop controls can be generated.

At this point, a method is also claimed which is advantageous on its own without the other features of the invention, namely a method for producing a tool, in particular a compound tool or a progressive tool, in which individual tools are arranged in mobile individual modules, and in which the mobile individual modules can be put together to form an individual module cluster. As a result, extraordinary individualisation options can be achieved in a particularly simple manner in terms of construction.

At this point, it is claimed that the methods described can also be supplemented by further technical features described here, in particular by features of the apparatus, in order to advantageously further develop the methods and/or to be able to present and/or formulate method specifications even more precisely.

It goes without saying that the features of the solutions described above and/or in the claims can also be combined if necessary in order to be able to cumulatively implement the advantages and effects that can be achieved here.

In any case, with the present invention, the masses to be moved, in particular during the actual work cycle, can be significantly reduced since only the individual tools have to be actuated.

Further features, effects and advantages of the present invention are explained with reference to the attached drawing and the following description, in which the invention is illustrated and described by way of example.

Components which at least substantially correspond in terms of their function in the individual figures can be identified with the same reference symbols, with the components not having to be shown, numbered and/or explained in all figures.

In the drawings:

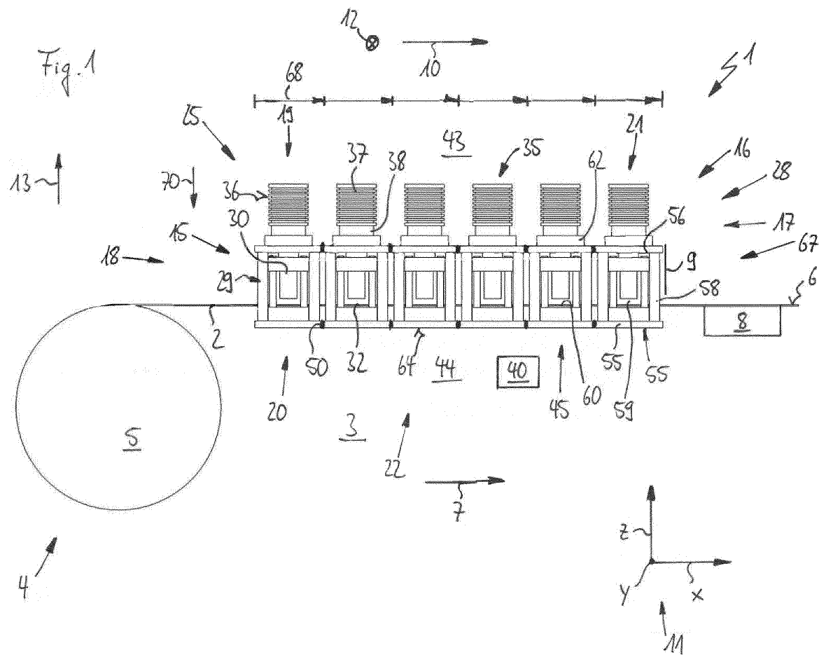

FIG. 1 is a schematic side view of an apparatus for working a web of material, comprising a plurality of individual modules, each with an individual tool integrated therein and each with an autonomously operating functional and/or drive unit integrated therein, in a first configuration;

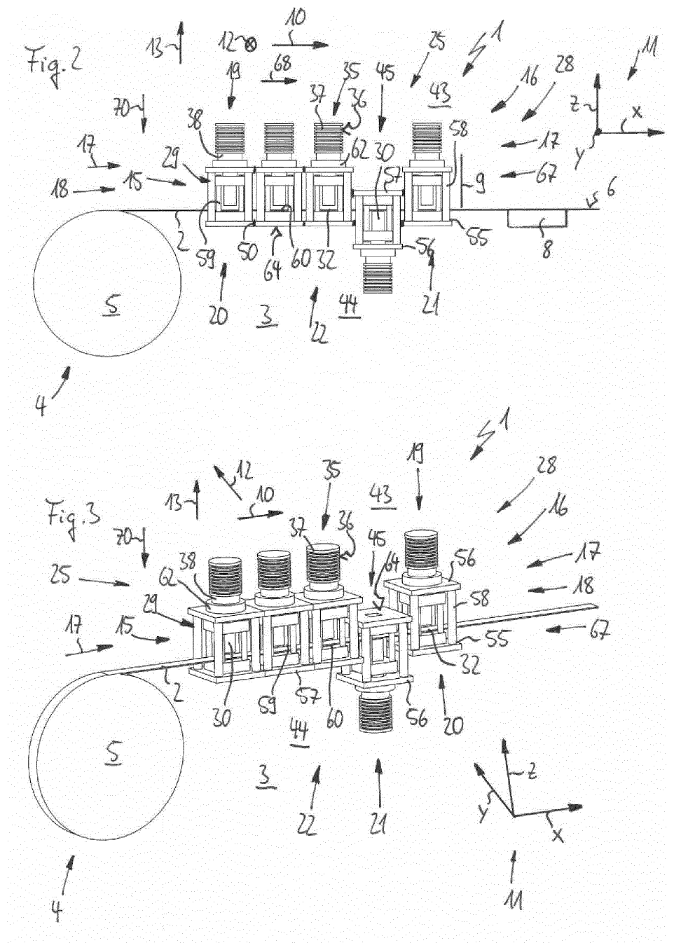

FIG. 2 is a further schematic side view of the apparatus shown in FIG. 1 in an alternative configuration, with a reduced number of individual modules which are arranged partially opposite one another;

FIG. 3 is a schematic perspective view of the alternative configuration of the apparatus shown in FIG. 2;

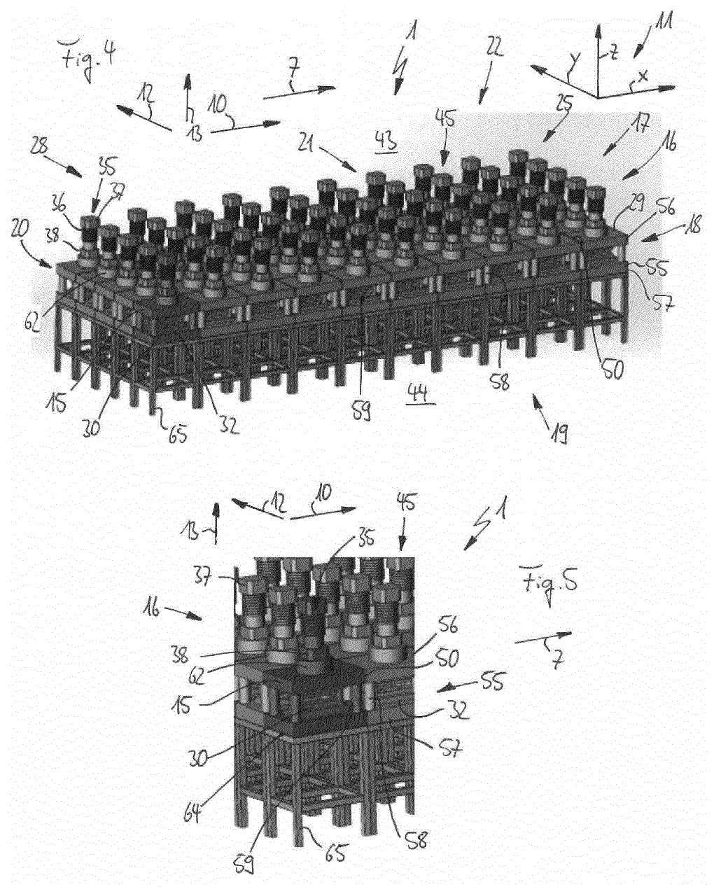

FIG. 4 is a schematic perspective view of a further configuration of the apparatus with a plurality of individual modules assembled into columns and rows; and

FIG. 5 is a schematic detail view of the further configuration shown in FIG. 4.

The apparatus 1 shown in FIG. 1 for working, in particular for separating and/or forming, a web of material 2 is, in this embodiment, a component of a system 3 for working the web of material 2 without machining, wherein the system 2 has a winding device 4 for unwinding the web of material 2 from a coil 5, and a production line 6 along which the web of material 2 is incrementally moved forward in the machine direction 7 of the apparatus 1, and is equipped for this purpose with a transport drive 8 that is not explained in detail.

The transport drive 8 is configured to move the web of material 2 together with the workpieces held therein (not shown and numbered separately) forward incrementally in the machine direction 7.

For example, the transport drive 8 pulls the web of material 2 together with the workpieces held therein along the production line 6, as a result of which the web of material 2 is further unwound from the coil 5.

In other words, this means that the individual workpieces are connected to the web of material 2, such that the workpieces held by the web of material 2 are transported towards individual modules 15 of the apparatus 1 and/or away from the respective individual modules 15, and the workpieces in the individual modules 15 are also connected and positioned with the web of material.

This is true at least until the workpieces are finally separated from the web of material 2 and isolated. This can be done on the apparatus 1 itself, provided that the apparatus 1 is set up accordingly, or at a later point in time on another working machine (not shown here).

In any case, the web of material 2 has a plurality of designated workpieces and a corresponding designated residual web matrix (also not shown and numbered separately) as a result of the working process in the apparatus 1, the workpieces of the web of material 2 being temporarily fixed in the designated residual web matrix of the web of material 2.

In this respect, the individual workpieces in the apparatus 1 are transported incrementally in the machine direction 7 as a group of workpieces connected to the web of material 2.

In the machine direction 7 further downstream on the production line 6 behind the apparatus 1, an optional separating device 9 can also be arranged in order to subsequently cut the web of material 2 worked as a continuous web into material web segments (not numbered), or the worked web of material 2 can be returned as a continuous web rolled up for further working.

As already mentioned above, the separating device 9 can optionally be configured, in addition or as an alternative, to separate the workpieces produced in the web of material from the web of material 2 and/or from the residual web matrix of the web of material 2.

The apparatus 1 extends with its longitudinal extension 10 along the x-axis of a Cartesian coordinate system 11, this x-axis running in the machine direction 7, and with its width extension 12 along the y-axis of the Cartesian coordinate system 11, this y-axis running transverse to the machine direction 7. Furthermore, the apparatus 1 also has a vertical extension 13 which runs along the z-axis of the Cartesian coordinate system 11.

In this embodiment, the apparatus 1 is characterised by a total of six individual modules 15 (numbered only as an example) which are directly connected to one another in a fixed but detachable manner.

The individual modules 15 are fastened together to form a rigid arrangement 16 that can be easily dismantled.

The individual modules 15 here form a column unit 17 with a single column arrangement 18, with the column unit 17 and the column arrangement 18 extending in the machine direction 7.

Furthermore, the individual modules 15 here form a row unit 19 with six row arrangements 20 which extend transverse to the machine direction 7.

Each of the row arrangements 20 forms a working station 21 (numbered only as an example) of the apparatus 1, as a result of which the apparatus 1 comprises a total of six working stations 21 in this embodiment.

In this respect, the apparatus 1 can be used in the manner of a progressive tool 22 with six working stations 21 arranged one behind the other in the machine direction 7.

The apparatus 1 also has an arrangement matrix 25, by means of which the individual modules 15 can be arranged in a defined manner both in the machine direction 7 (see FIGS. 1 to 3) and also transverse to the machine direction 7 (see FIGS. 4 and 5).

The individual modules 15, which are detachably fastened to one another, also form an individual module cluster 28 which can be assembled in a highly variable manner using the individual modules 15 present here.

The individual module cluster 28 made of the individual modules 15 is self-supporting. In this respect, the arrangement matrix 25 also has a self-supporting base body 29 made of individual modules 15.

The individual modules 15 each carry an individual tool 30 (shown with a reference number solely by way of example) by means of which the web of material 2 can be worked at a corresponding number of working positions 32 of the web of material 2 in order to produce corresponding workpieces on the web of material 2.

In this respect, the individual tools 30 are designed as individual modules 15.

For example, such working processes comprise separating processes, such as in particular cutting processes, including laser cutting, on the web of material 2, and/or forming processes, such as in particular bending or the like on the web of material 2, in order to produce corresponding workpieces on the web of material 2.

In any case, the apparatus 1 can be individually assembled by means of the individual modules 15 that can be detachably fixed directly to one another, and in this respect individual working processes are also possible at the many working positions 32 of the web of material 2 in order to produce a plurality of workpieces on the web of material 2.

In addition, the individual modules 15 are each autonomously driven by a motor, each by means of an autonomously operating functional and/or drive unit 35, such that each individual tool 30 of an individual module 15 can interact with the web of material 2 individually and independently of other individual tools 30.

In this embodiment, each of the autonomously operating functional and/or drive units 35 comprises a direct drive 36 with a servo-hydrostatic motor 37.

In addition, each individual module 15 is provided with a distance measurement device 38, by means of which the autonomously operating functional and/or drive unit 35 of the individual module 15 on the one hand and the individual tool 30 of the individual module 15 on the other hand can be controlled and/or regulated in real time during a work cycle.

The distance measurement device 38 is seated directly on the autonomously operating functional and/or drive unit 35, such that the latter can move the individual tool 30 with respect to the web of material 2 with particular precision.

The apparatus 1 also has a suitable control and/or regulating device 40 for the corresponding control and/or regulation—in particular as a function of the distance measurement devices 38—of the autonomously operating functional and/or drive units 35 and the individual tools 30.

A quick exchange of individual modules 15 on the individual module cluster 28 is particularly easy, since the individual modules 15 can be inserted from two sides 43 and 44 into slots 45 defined by individual modules 15, namely from the upper side 43 and from the lower side 44 of the individual module cluster 28 along the z-axis.

In particular, the individual modules 15 can accordingly also be inserted and/or removed on both sides of the arrangement matrix 25.

Such an insertion and/or removal of individual modules 15 is particularly easy in this embodiment using coupling devices 50 (numbered only as an example) which comprise coupling elements (not shown here) in the form of detachable tongue and groove connections (not shown), which can be loved by means of stay bolts (not shown).

The respective individual modules 15 have a frame part 55 which can be detachably fixed to a further frame part 55 of at least one further individual module 15, such that the individual module cluster 28 is fixed together with the frame parts 55 connected to one another.

The frame part 55 has two end plate parts 56 and 57 which are arranged at a distance from each other by means of column parts 58 (numbered only as an example), in such a way that a working space 59 for receiving an individual tool 30 is present between them. A working path 60 (numbered only as an example), along which the working the web of material 7 takes place, runs through this receiving space 59 in the machine direction 7.

The first end plate part 56 has a receiving device 62 for arranging the autonomously operating functional and/or drive unit 35 on the individual module 15, while the second end plate part 57 has a contact surface 64 for a frame part 65 (see FIGS. 4 and 5) of the apparatus 1.

The individual tools 30 described here, designed as individual modules 15, are connected to form an upper tool 67 of the apparatus 1.

In order to work the web of material 2 with a plurality of individual tools 30 during a work cycle, the web of material 2 is transported incrementally through the working spaces 59 of the individual modules 15 with feed cycles 68, with a feed cycle 68 approximately corresponding to at least one length of an individual module 15 in the machine direction 7.

Between two feed cycles 68, the individual tools 30 formed as individual modules 15 and the web of material 2 do not move relative to one another, and in this case a work cycle can be carried out in which autonomously operating functional and/or drive units 35 also independently perform working strokes 70 in the direction of the z-axis can execute, such that each of the individual tools 30 can interact with the web of material 2 at the corresponding working positions 32.

The individual working strokes 70 of the plurality of individual tools 30 during the work cycle divide the total drive power of the apparatus 1 into individual drive powers, such that the apparatus 1 can be operated with a lower input power.

In other words, the individual tools 30 are driven and/or operated in a decentralised manner.

According to the illustrations in FIGS. 2 and 3, the apparatus 1 is alternatively configured in particular such that one of five existing individual modules 15 is arranged on the production line 6 rotated by 180°. This once again underscores the great design possibilities of the present invention. Otherwise, the alternative configuration corresponds to the illustration of FIG. 1, and in this respect reference is made to the relevant description in order to avoid repetition.

According to the illustrations according to FIGS. 4 and 5, the apparatus 1 has an individual module cluster 28 with alternative column and row units 17 and/or 19, with the column unit 17 comprising a total of five column arrangements 18 (numbered only as an example) and the row unit 19 comprising a total of ten row arrangements 20. In this respect, the further alternative configuration of the apparatus 1 comprises a two-dimensional arrangement matrix 25. The frame parts 65 are also shown below the individual module cluster 28. Otherwise, the further alternative configuration corresponds to the illustration according to FIG. 1, and in this respect reference is made to the relevant description in order to avoid repetitions here as well.

At this point it should be explicitly pointed out that the features of the solutions described above and/or in the claims and/or figures can also be combined if necessary in order to be able to cumulatively implement and/or achieve the features, effects and advantages explained.

It goes without saying that the apparatus 1 explained above is only a first embodiment of the invention. In this respect, the embodiment of the invention is not limited to the explained configurations of the apparatus 1.

All features disclosed in the application documents are claimed to be essential to the invention, provided they are novel over the prior art, either individually or in combination.

### LIST OF REFERENCE SIGNS

1 apparatus for working a web of material
2 web of material
3 system for working a web of material
4 winding device
5 coil
6 production line
7 machine direction
8 transport drive
9 separating device
10 longitudinal extension
11 Cartesian coordinate system
12 width extension
13 height extension
15 individual modules
16 arrangement
17 column unit
18 column arrangement
19 row unit
20 row arrangements
21 working stations
22 progressive tool
25 arrangement matrix
28 individual module clusters
29 self-supporting base body
30 individual tools
32 working positions
35 autonomously operating functional and/or drive unit
36 direct drive
37 servo-hydrostatic motor
38 distance measurement device
40 control and/or regulating device
43 upper side
44 lower side
45 slots
50 coupling devices
55 frame part
56 first end plate part
57 second end plate part
58 column parts
59 working space
60 working path
62 receiving device
64 contact surface
65 frame part
67 upper tool
68 feed cycle
70 working strokes

1. Apparatus (1) for working, in particular for working without machining, for example for separating and/or forming, a web of material (2), having a plurality of individual tools (30) for different manners of working the web of material (2) with designated workpieces temporarily held therein, and having a machine direction (7) along which the web of material (2) with the designated workpieces and the plurality of individual tools (30) can be moved incrementally relative to one another in such a way that the web of material (2) can be worked multiple times with-in one work cycle by means of the plurality of individual tools (30), wherein each of the plurality of the individual tools (30) are designed as individual modules (15) which can be fixed to one another to form an individual module cluster (28), but can be detached as well.

2. Apparatus (1) according to claim 1, wherein each of the plurality of individual tools (30) are designed as individual modules (15), driven autonomously by a motor, of an individual module cluster (28) and/or the individual tools (30) are designed as individual modules (15) having a distance measurement device (38) for controlling and/or regulating each of the individual tools (30).

3. (canceled)

4. Apparatus (1) according to claim 1 or 2, characterised in that the apparatus (1) is configured to move workpieces to be produced by means of the web of material (2) in the machine direction (7) along a production line (6).

5. Apparatus (1) according to any of claims 1 to 4, characterised in that a plurality of individual modules (15) are arranged together to form a column and row arrangement (18, 20), wherein the column arrangement (18) extends as one column or multiple columns in the machine direction (7) and the row arrangement (20) extends as two or more rows transverse to the machine direction (7), whereby in particular each of the plurality of the individual modules (15) are arranged detachably fixed to one another to form at least one column unit (17) and/or at least one row unit (19), wherein in particular one row unit (19) forms a working station (21), and a plurality of working stations (21) are arranged one behind the other in the machine direction (7).

6. (canceled)

7. Apparatus (1) according to any of claims 1 to 5, characterised in that an individual module cluster (28) made up of individual modules (15) is self-supporting.

8. Apparatus (1) according to any of claims 1 to 7, characterised in that the apparatus (1) has an arrangement matrix (25) in which the individual modules (15) can be arranged to form an individual module cluster (28), and whereby in particular individual modules can be inserted into and/or removed from the arrangement matrix (25), in particular the individual module cluster (28), from at least two different sides (43, 44), in particular two opposite sides (43, 44).

9. (canceled)

10. Apparatus (1) according to claim 8, characterised in that the arrangement matrix (25) has slots (45) for receiving each of the plurality of individual modules (15), whereby in particular slots (45) are delimited directly by one or more surrounding individual modules (15).

11. (canceled)

12. Apparatus (1) according to claim 8 or 10, characterised in that the arrangement matrix (25) has a self-supporting base body (29) which is formed by means of the individual modules (15).

13. Apparatus (1) according to any of claims 1 to 12, characterised in that an individual module cluster (28) comprises both individual modules (15) having individual tools (30) and empty modules.

14. Apparatus (1) according to any of claims 1 to 13, characterised in that the individual modules (15) each have an autonomously operating functional and/or drive unit (35) and whereby in particular each of the autonomously operating functional and/or drive units (35) has a direct drive (36), the direct drive (36) in particular comprising a servo-hydrostatic motor (37), whereby in particular each of the autonomously operating functional and/or drive units (35) can be arranged on the individual module (15) in any position, and whereby in particular each of the autonomously operating functional and/or drive units (35) can be controlled and regulated according to a distance measurement device (38) of the individual module (15), whereby in particular each of the autonomously operating functional and/or drive units (35) can be controlled and regulated according to a hardness of a material region of the web of material (2), and whereby in particular each of the autonomously operating functional and/or drive units (35) can be controlled and regulated according to the forces and/or moments acting on the apparatus (1).

15. (canceled)

16. (canceled)

17. (canceled)

18. (canceled)

19. (canceled)

20. (canceled)

21. (canceled)

22. Apparatus (1) according to any of claims 1 to 14, characterised in that the individual module (15) has a frame part (55) which can be detachably fixed to a further frame part (55) of at least one further individual module (15), wherein an individual module cluster (28) can be produced by means of frame parts (55) of the individual modules (15) connected to one another, whereby in particular the frame part (55) has a coupling device (50) by means of which each of the plurality of the individual modules (15) can be operatively connected to one another, and whereby in particular the coupling device (50) has coupling elements which are preferably arranged on all four sides of the frame part (55), the coupling elements acting in particular in a positive and/or non-positive manner.

23. (canceled)

24. (canceled)

25. Apparatus (1) according to claim 22, characterised in that the frame part (55) has opposite end plate parts, wherein the two end plate parts (56, 57) are arranged at a distance from one another by column parts (58), whereby in particular a first end plate part (56, 57) of the two end plate parts (56, 57) has a receiving device (62) for an autonomously operating functional and/or drive unit (35), and a second end plate part (56, 57) of the two end plate parts (56, 57) has a contact surface (64) for a frame part (65).

26. (canceled)

27. (canceled)

28. Apparatus (1) according to any of claims 1 to 25, characterised in that the apparatus (1) is configured to carry out working processes on the web of material (2), in particular on work-pieces of the web of material (2), in a state of a self-optimising system.

29. Progressive tool (22) for working, in particular for working without machining, for example for separating and/or forming, a web of material (2), having working stations (21) arranged one behind the other in the machine direction (7), by means of which working positions (32) of the web of material (2) can be worked successively, wherein the progressive tool (22) comprises an apparatus (1) according to any of the preceding claims.

30. Individual module (15) for carrying at least one individual tool (30) for working, in particular for working without machining, for example for separating and/or forming, a web of material (2) with designated workpieces temporarily held therein, the individual module (15) having a working path (60) along which the web of material (2) can be transported incrementally in the machine direction (7), and/or a coupling device (50) with coupling elements for a fixed but detachable coupling to at least one further individual module (15), and/or an autonomously operating functional and/or drive unit (35) for directly driving the at least one individual tool (30) with respect to the working path (60), and/or a distance measurement device (38) for controlling and/or regulating the autonomously operating functional and/or drive unit (35) and/or the at least one individual tool (30).

31. (canceled)

32. (canceled)

33. (canceled)

34. (canceled)

35. (canceled)

36. (canceled)

37. Method for working, in particular for working without machining, for example for separating and/or forming, a web of material (2) with designated workpieces temporarily held therein, wherein the web of material (2) moves forward incrementally in the machine direction (7) and is worked intermittently multiple times by individual tools (30) during a work cycle, wherein there is more than one working stroke (70), with respect to the individual tools (30), for working the web of material (2) during the work cycle.

38. Method according to claim 37 for working, in particular for working without machining, for example for separating and/or forming, a web of material (2) with designated workpieces temporarily held therein, wherein the web of material (2) moves forward incrementally in the machine direction (7) and is worked intermittently multiple times by individual tools (30) during a work cycle, wherein the individual tools (30) are activated and/or driven in a decentralised manner during this work cycle.

39. (canceled)

40. (canceled)

41. (canceled)

42. Method according to claim 37 or 38, characterised in that fewer work steps are carried out on the web of material (2) by means of the individual tools (30) during the work cycle per working stroke (70) relative to the web of material (2) than there are individual tools (30) present overall.

43. (canceled)

44. (canceled)

45. Method according to any of claims 37 to 42, characterised in that, during the work cycle, the sequence in which individual tools (30) are actuated for working the web of material (2) is selected as a function of the intensity of the designated working forces of each of the individual tools (30).

46. Method according to any of claims 37 to 45, characterised in that, during the work cycle, the sequence in which the individual tools (30) are actuated for working the web of material (2) is selected as a function of the location at which the designated working forces of each of the individual tools (30) are applied.

47. Method according to any of claims 37 to 46, characterised in that, during the work cycle, the sequence in which individual tools (30) are actuated for working the web of material (2) is selected as a function of the designated force load distribution on the web of material (2) and/or on the frame parts (65) supporting the web of material (2).

48. (canceled)

49. (canceled)

50. (canceled)
